(19) United States
(12) Patent Application Publication
(10) Pub. No.: US 2006/0127633 A1
(43) Pub. Date: Jun. 15, 2006

(54) Reinforced wood product and methods for reinforcing a wood product

(76) Inventors: Alkiviadis G. Dimakis, Federal Way, WA (US); Lionel Brightwell, Boise, ID (US); John W. Kerns, Tacoma, WA (US); Amar N. Neogi, Kenmore, WA (US); Glen Robak, Boise, ID (US); Thomas F. Schulner, Tacoma, WA (US); James E. Smith, Puyallup, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/009,762

(22) Filed: Dec. 10, 2004

(51) Int. Cl. B32B 5/12

(52) U.S. Cl. 428/105

(57) ABSTRACT

A reinforced wood product and methods for reinforcing a wood product are provided. In a first method of manufacture, one or more cords are placed between a first wood layer and a second wood layer in a continuous length. The cords may be constructed from metal, plastic, rubber, or the like. The wood layers and the cords are compressed to form a floor panel or a wall panel. In a second method of manufacture, one or more cords are applied to separate wood sections of a first wood layer. Separate wood sections of a second wood layer are aligned with the wood sections of the first layer to form lap joints in a staggered formation. The first wood sections, cords and second wood sections are then compressed to form a wood product, such as a wall panel or floor panel.

### FIELD OF THE INVENTION

This invention relates generally to a reinforced wood product, such as a wall panel or floor panel. More specifically, the present invention relates to wood layers which are reinforced by cords attached on a top or bottom surface of at least one of the layers. The cords are constructed from rubber, metal, plastic, or the like.

### BACKGROUND OF THE INVENTION

It is generally known to provide wood-constructed walls and/or flooring for a room or frame, such as a scaffold. The walls and/or flooring must be capable of bearing a load such as, for example, the weight of individuals, raw materials, machinery, and loads resulting from naturally occurring conditions, such as weather. The wall and/or floor may be constructed from panels consisting of two or more wood layers. In an example, a typical scaffold floor can be constructed from Laminated Veneer Lumber (LVL) planks which include multiple wood layers that are pressed and bonded together. In some instances, the scaffold floor is located at a significant height of a building under construction. The wood used to construct the scaffold floor must ensure a safe environment for workers or other individuals present on the scaffold floor.

Unfortunately, inspection of the floor or wall does not always lead to detection of cracks or weaknesses within the wood. When a load is placed on fractured or otherwise ruptured wood, the wood cannot sustain the load. The wood then breaks, or “fails”. At times the defective wood can fail immediately, causing the load placed on the wood to fall through or from the floor. This is referred to as a “catastrophic failure”. Because the wood fails immediately, an individual is not provided with sufficient notice to leave the scaffold floor when the floor is incapable of bearing a load. The end result may be an accident and/or significant injuries or damage to property.

A need, therefore, exists for a wood product, such as a floor or wall constructed from reinforced wood layers wherein the floor/wall has reserved strength capacity which is greater than known floors/walls and wherein the floor/wall provides sufficient notice of failure after rupturing or breaking to prevent accidents, significant injuries, or damage to property.

### SUMMARY OF THE INVENTION

The present invention provides a reinforced wood product and methods for reinforcing a wood product. The wood product may be formed from wood layers, such as in laminated veneer lumber, plywood or like applications. In a first method of manufacture, one or more cords are placed between a first wood layer and a second wood layer in a continuous length. The cords may be constructed from rubber, plastic, metal, or the like. The wood layers and the cords are compressed to form a wall panel or floor panel. The cords are fixed between the wood layers due to a chemical and/or mechanical bond between the cords and the wood layers when the wood layers are heated and pressed against each other. For cords of lower density, i.e., a lower number of cords per inch, a spacing between cords is sufficient to allow bonding between the wood layers. Conventional wood adhesives may be present between the wood layers, such as Phenol Formaldehyde (PF). For cords of higher density, i.e., a higher number of cords per inch, a chemical bond is required to attach the cords to the wood layers. Chemical bonding may be supplied by a high strength engineered adhesive, such as an epoxy.

In a second method of manufacture, a first wood layer is comprised of two or more unattached wood sections. One or more cords are sized to correspond to each wood section and are attached to at least one of the wood sections. A second wood layer may be comprised of two or more unattached wood sections. The wood sections of the second layer are aligned with the wood sections of the first layer wherein the cords are between the first wood layer and the second wood layer. This is referred to as a “lay-up” process. The first wood layer, cords and second wood layer are then compressed to form a wood product, such as, for example, a wall panel or floor panel.

In another embodiment, a reinforced wood product is provided. The reinforced wood product has a first wood layer and a second wood layer. An adhesive is present between the first wood layer and the second wood layer. One or more cords are positioned longitudinally between the first wood layer and the second wood layer. The cords are in contact with the first wood layer and the second wood layer. As a result, stiffness, strength and impact resistance associated with a combination of the first wood layer, the cords and the second wood layer are greater than that demonstrated by a combination of the first wood layer and the second wood layer. In addition, energy absorption associated with a combination of the first wood layer, the cords and the second wood layer is greater than that demonstrated by a combination of the first wood layer and the second wood layer. The cords may be constructed from a material selected from a group consisting of metal, plastic, rubber, fiberglass, carbon and graphite.

It is, therefore, an advantage of the present invention to provide a reinforced wood product and methods for reinforcing a wood product wherein the reinforced wood product may bear heavier loads than non-reinforced wood products.

It is a further advantage of the present invention to provide a reinforced wood product and methods for reinforcing a wood product wherein the reinforced wood product provides sufficient notice to an individual of structural defects in a floor or wall to prevent accidents and/or injuries to person or property.

Additional features and advantages of the present invention are described in, and will be apparent from, the detailed description of the present embodiments and from the drawings.

### BRIEF DESCRIPTION OF THE DRAWINGS

The embodiments of the present invention are described in detail below with reference to the following drawings.

FIG. 1 is a cross-sectional view of reinforced layers of a wood product in an embodiment of the present invention;

FIG. 2 is a cross-sectional view of reinforced layers of a wood product in another embodiment of the present invention;

FIG. 3 is a partial side view of a cord which reinforces wood layers of a wood product in an embodiment of the present invention;

FIG. 4 is a top plan view of a scrim which acts as a carrier for cords in an embodiment of the present invention;

FIG. 5A is a cross-sectional view of mechanical bonding between reinforced wood layers of a wood product in an embodiment of the present invention;

FIG. 5B is a side view of the reinforced wood layers of the wood product in FIG. 5A;

FIG. 6 is a cross-sectional view of chemical bonding between a wood layer of a wood product and cords in an embodiment of the present invention;

FIG. 7 is an exploded view of an alignment between a reinforced wood layer of a wood product and cords in an embodiment of the present invention;

FIG. 8 is an exploded view of an alignment between a reinforced wood layer of a wood product and cords in another embodiment of the present invention;

FIG. 9 is a plan view of an arrangement of cords onto a wood layer of a wood product in an embodiment of the present invention;

FIG. 10 is a graph illustrating modulus of elasticity for reinforced wood products in an embodiment of the present invention for two different grades of wood;

FIG. 11 is a graph illustrating modulus of rupture for reinforced wood products in an embodiment of the present invention for two different grades of wood;

FIG. 12 is a graph illustrating load-deformation response for reinforced wood products comprised of wood having a high modulus of elasticity in an embodiment of the present invention;

FIG. 13 is a graph illustrating load-deformation response for reinforced wood products comprised of wood having a low modulus of elasticity in an embodiment of the present invention;

FIG. 14 is a graph illustrating load-deformation response for reinforced wood products comprised of wood having a low modulus of elasticity in another embodiment of the present invention;

FIG. 15 is a graph illustrating tensile strength for reinforced wood products in an embodiment of the present invention; and

FIG. 16 is a graph illustrating tensile strength for reinforced wood products in a lap joint configuration in an embodiment of the present invention.

### DETAILED DESCRIPTION OF THE INVENTION

The present invention relates to a reinforced wood product and methods for reinforcing a wood product. More specifically, the present invention provides a first wood layer and a second wood layer having one or more cords positioned between the first and the second layer. The cords may be constructed from metal, plastic, rubber, fiberglass, carbon, graphite, or the like. In an embodiment, the cords are continuous and become attached to the first layer and the second layer when the first layer and the second layer are compressed. In another embodiment, the cords are sized to correspond to a length of a single section of a wood layer prior to a lay-up process. The cords are attached to the first layer and the second layer when the first layer and second layer are compressed. In each embodiment, the reinforced wood product demonstrates greater energy absorption than non-reinforced wood products. As a result, the reinforced wood product fails at a more gradual rate than a non-reinforced wood product and provides sufficient notice to an individual of damage to prevent accidents and injuries to person or property.

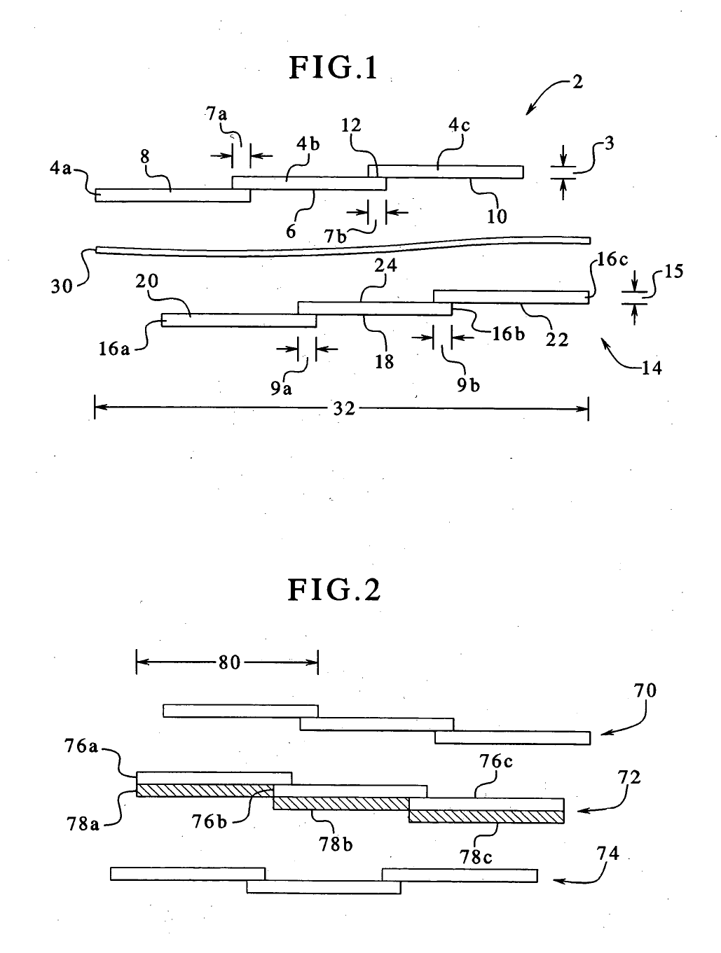

Referring now to the drawings wherein like numerals refer to like parts, FIG. 1 illustrates a wood layer 2 which is comprised of sections 4a, 4b, 4c in a lap joint configuration. Specifically, a bottom surface 6 of section 4b is positioned on a top surface 8 of the section 4a. A bottom surface 10 of section 4c is positioned on a top surface 12 of section 4b. An overlap 7a exists between the section 4a and the section 4b. An overlap 7b exists between the section 4b and the section 4c. The overlap 7a may or may not be equal in length to the overlap 7b. Similarly, a wood layer 14 has sections 16a, 16b, 16c which are positioned on one another. To this end, a bottom surface 18 of section 16b is positioned on a top surface 20 of section 16a. A bottom surface 22 of section 16c is positioned on a top surface 24 of section 16b. An overlap 9a exists between the section 16a and the section 16b. An overlap 9b exists between the section 16b and the section 16c. The overlap 9a may or may not be equal in length to the overlap 9b. All of the overlaps 7a, 7b, 9a, 9b may be in a range from 1 inch to 8 inches. The overlaps 7a, 7b, 9a, 9b, also referred to as “lap joints”, are staggered to reduce thickness at an overlap location and improve strength capacity of the manufactured panel.

The wood layers 2, 14 are stacked or placed adjacent to one another as part of a conventional “lay-up” process. Namely, the layers 2, 14 are staggered prior to being compressed to form a wood product, such as a floor panel or wall panel. A press pressure for the compression may be in a range from 250 psi to 400 psi. During compression, section 4a is bonded to 4b which is bonded to section 4c. Likewise, section 16a is bonded to section 16b which is bonded to section 16c. Overall, the wood layer 2 is bonded to the wood layer 14. An adhesive (not shown in FIG. 1) may be provided between the wood layers 2, 14 to assist in attachment of the wood layers 2, 14 during compression. The adhesive may be phenol formaldehyde (“PF”), phenol resorcinol formaldehyde (“PRF”), or the like.

In an embodiment, the wood layers 2, 14 serve as veneers which eventually form laminated veneer lumber. The resulting LVL may have a modulus of elasticity in a range from 0.5E6 psi to 3.0E6 psi. The LVL may also have a modulus of rupture in a range from 3,000 psi to 15,000 psi. In general, the wood layers 2, 14 may have a thickness 3, 15 in a range from 0.050 inches to 0.15 inches. Individual sections 4a, 4b, 4c or 16a, 16b, 16c may have a length in a range from 2 to 12 feet.

A scrim 30, illustrated in FIG. 4, may be positioned between the wood layer 2 and the wood layer 14. The scrim 30 may be constructed from plastic and may be planar in shape having a mesh-like body. One or more cords 50 may be integrated within or on a face 31 of the scrim 30 wherein the scrim 30 acts as a carrier for the cords 50. FIG. 4 illustrates exaggerated spacing between cords 50 for the purpose of better explaining the arrangement of cords 50 onto the scrim 30. However, any spacing of cords 50 which is sufficient to reinforce wood layers is contemplated. The cords 50 may be constructed from any material suitable for providing reinforcement to wood layers including, but not limited to, metal, plastic, rubber, fiberglass, carbon, graphite, or the like. A single cord 50 constructed from a metal is illustrated in FIG. 3. In an embodiment, the metal is steel. The cord 50 has at least two strands 52 which are wrapped in a spiral manner along a length 54 of the cord 50. An individual strand 56 is wrapped around the strands 52 in an opposing spiral manner. For example, the strands 52 may be wrapped in a spiral manner in a clockwise direction. The individual strand 56 may be wrapped around the strands 52 in a counter-clockwise spiral manner. In an embodiment, the cord 50 has a diameter in a range from 0.030 inch to 0.060 inch. A density of the scrim 30 may be defined by a number of cords 50 per inch along a width of a scrim or of a wood layer. Accordingly, a low density may correspond to two to four cords 50 per inch while a high density may correspond to five to sixteen cords 50 per inch. It is appreciated that any of the wood layers may be reinforced by the cords 50 without the use of the scrim 30. In such an embodiment, the cords 50 may be directly applied to one or more of the wood layers. It is further appreciated that any number of layers of sheets 30 or cords 50 may be implemented to reinforce the wood layers and that any number of wood layers may be implemented as deemed necessary for a particular wood product, such as a floor panel or wall panel.

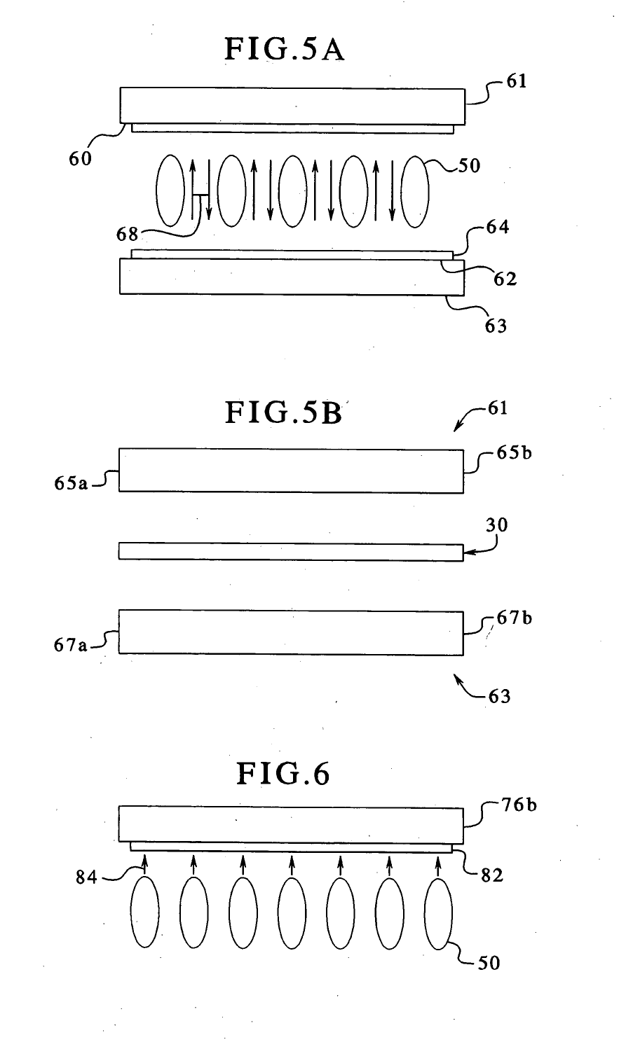

The scrim 30 may have a length 32 which corresponds to the wood layers 2, 14. In an embodiment, the scrim 30 is positioned in a continuous length between the wood layer 2 and the wood layer 14. The scrim 30 is aligned wherein the length 54 of each of the cords 50 is substantially parallel to a grain (not shown) of the wood layers 2, 14. The cords 50 become embedded within the wood layers 2, 14 after compression of the wood layers 2, 14 and the scrim 30. FIG. 5B illustrates a side view of an embodiment in which equal sized wood sections 61, 63 are aligned directly across from one another prior to compression. Such an arrangement may be demonstrated in applications such as plywood or other engineered woods comprised of a plurality of layers which are compressed. Ends 65a, 65b of the layer 61 are directly aligned with ends 67a, 67b of the layer 63. The scrim 30 is placed between the layers 61, 63. At a low density, the cords 50 are attached to the wood layers 61, 63 via a mechanical bond, as illustrated in FIG. 5A. Specifically, heat and pressure from the compression process cause attachment of a bottom surface 60 of the wood layer 61 to a top surface 62 of the wood layer 63. An adhesive 64, such as, for example, phenol formaldehyde (“PF”) or phenol resorcinol formaldehyde (“PRF”) may be placed on the top surface 62 and/or the bottom surface 60 to assist in attaching the wood layers 61, 63. The attachment occurs between each of the cords 50, as shown by the arrows 68 and causes each of the cords 50 to become embedded within the wood layer 61 and/or the wood layer 63.

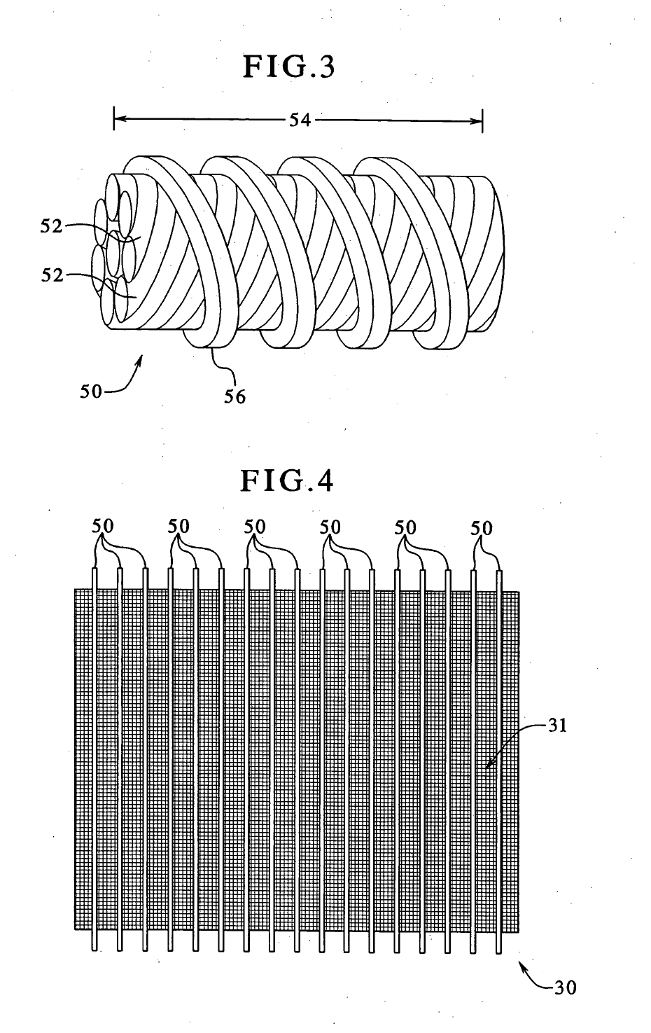

FIG. 2 illustrates another method for reinforcing a wood product having wood layers 70, 72, 74 stacked in a lap joint configuration, namely, placement of a first end of one section on an end of an adjacent section. The wood layer 72 is comprised of sections 76a, 76b, 76c. Individual scrims 78a, 78b, 78c having cords (not shown) may be sized to correspond to a length 80 of each of the sections 76a, 76b, 76c. The scrims 78a, 78b, 78c may be attached, respectively, to the sections 76a, 76b, 76c prior to placement of the wood layer 72 between the wood layer 70 and the wood layer 74 in the lay-up process. In an example, and as illustrated in FIG. 6, an adhesive 82, such as PF or PRF may provide a bond 84 between, for example, the sheet 78b and the section 76b. At a higher density of cords 50, chemical compatibility may be necessary for attachment of the cords 50 to a wood layer. Accordingly, a primer may be applied to the cords 50 which is compatible with PF or PRF type adhesives. In some embodiments, a scrim having a high density of cords may require that the cords are treated with, for example, an epoxy. The wood layers 70, 72, 74 may eventually be compressed to form a floor panel or wall panel. After compression, the cords 50 may become embedded within the wood layer 72 and/or the wood layer 74. It is contemplated that cords may be applied in a symmetrical configuration, i.e., each cord being equidistant from a center of a compressed panel with respect to an overall height of the panel. However, this should not be considered to preclude any configuration of cords which may provide reinforcement to a wood layer or a wood product consisting of a plurality of wood layers.

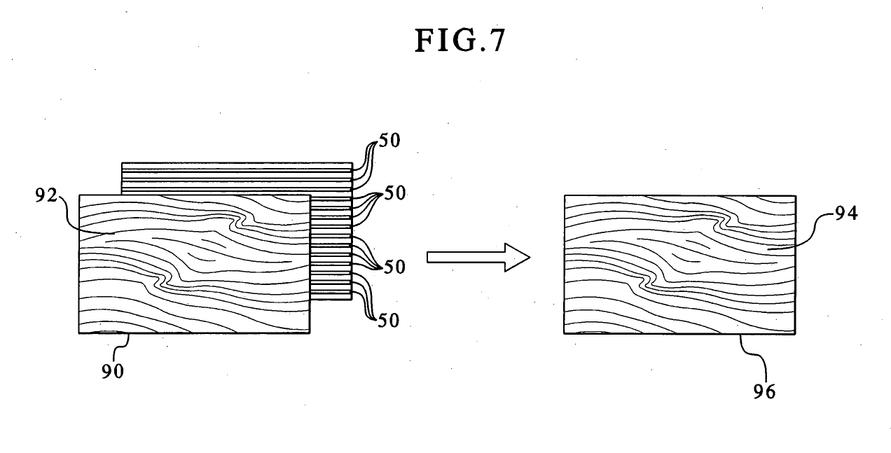

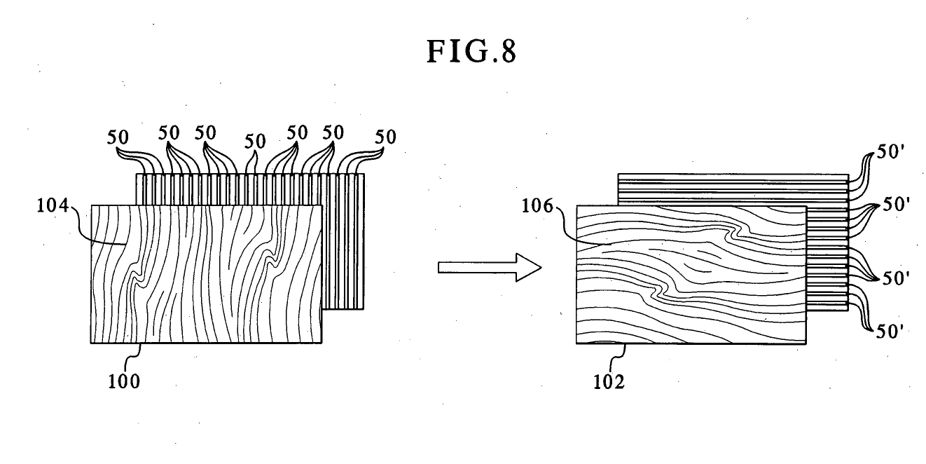

In an embodiment, illustrated in FIG. 7, the cords 50 are aligned with a grain 92 of a wood layer 90 during a lay-up process. Alignment with the grain 92 provides optimum reinforcement for the wood layer 90 as strength of wood is generally greatest in a direction parallel to the grain. The wood layer 90 and cords 50 may then be aligned with a grain 94 of a wood layer 96. This type of arrangement may be used for wood products, such as, for example, Laminated Veneer Lumber (LVL), Engineered Strand Lumber (ESL), Parallel Stress Lumber (PSL), Oriented Strand Board (OSB) or the like. In another embodiment, illustrated in FIG. 8, a wall panel or floor panel may have wood layers 100, 102 arranged in a longitudinal, and subsequently transverse, orientation as demonstrated in typical plywood applications. This type of arrangement provides a more balanced construction and is useful in applications in which two-directional strength is necessary to transfer loads to supports. A grain 104 for the wood layer 100 may be aligned in a first direction. The cords 50 attached to the layer 100 may be substantially parallel to the grain 104. The wood layer 102 may be arranged wherein a grain 106 is aligned in a second direction wherein the first direction and the second direction are not parallel. Cords 50′ are parallel to the grain 106 of the layer 102. During the lay-up process, the grain 104 of the layer 100 and the cords 50 are non-parallel to the grain 106 and the cords 50′.

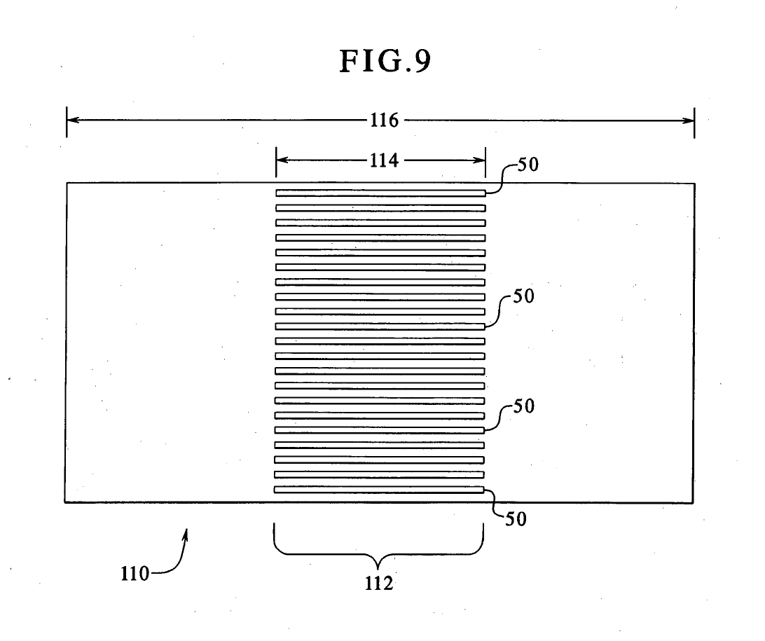

FIG. 9 illustrates another embodiment of the present invention in which a minimum amount of cords 50 are arranged on a wood layer 110. More specifically, the cords 50 are attached in an area 112 which may, for example, receive greater stress than adjacent areas of the wood layer 110. The cords 50 may have a length 114 which is sized to correspond to the area 112 and is less than a length 116 of the wood layer 110. Reinforcing only the area 112 may provide adequate reinforcement of a wood product at a lower cost of materials.

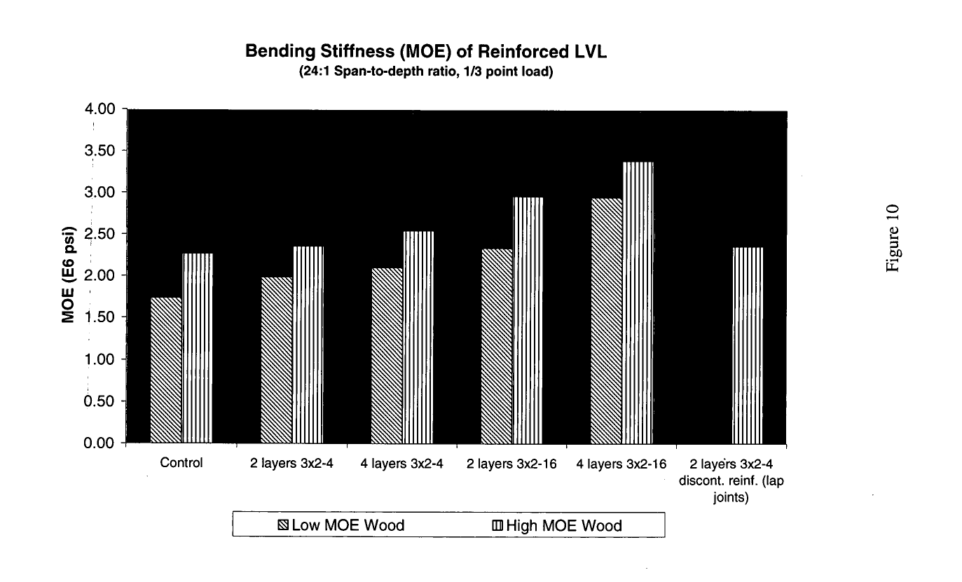

FIG. 10 illustrates results obtained when testing reinforced laminated veneer lumber (LVL) samples for modulus of elasticity (MOE). Reinforced samples of lumber having a low MOE, as well as samples of lumber having a higher MOE, were compared to non-reinforced LVL, referred to as a control group. A first level of reinforcement compared to the control group was 2 layers of metal cords comprising 3 strands which are wrapped by 2 strands, the cord density being 4 cords per inch. This type of reinforcement is referred to on the graph as “2 layers 3×2-4.” Additional reinforcement levels included 4 layers 3×2-4; 2 layers 3×2-16; 4 layers 3×2-16; and 2 layers 3×2-4 applied in a lap joint configuration. Samples of low MOE veneer lumber which were reinforced demonstrated a greater MOE than non-reinforced veneer lumber having a low MOE. Samples of high MOE veneer lumber which were reinforced demonstrated a greater MOE than non-reinforced veneer lumber having a high MOE. Most notably, LVL having a low MOE which was reinforced with 2 layers 3×2-16 demonstrated a greater MOE than non-reinforced LVL having a high MOE.

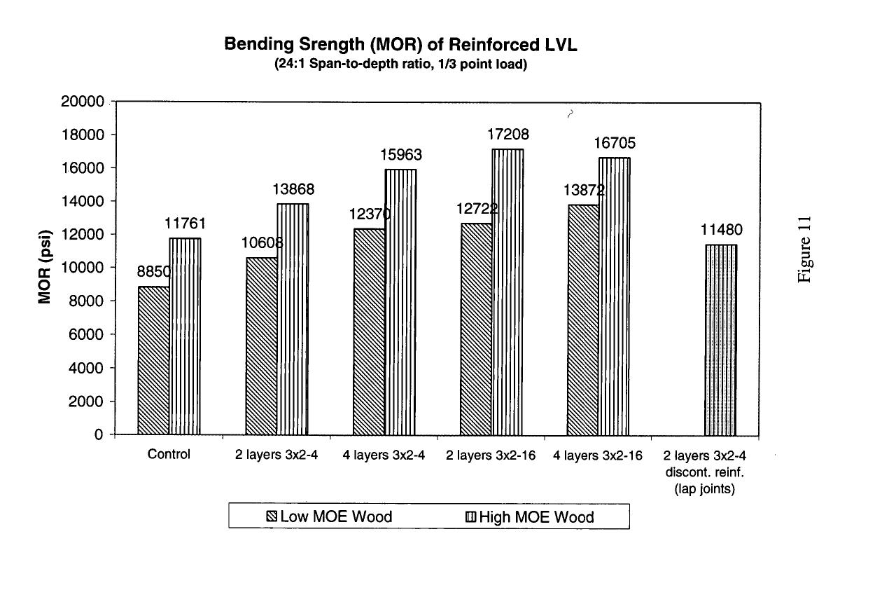

FIG. 11 illustrates results obtained when testing reinforced LVL samples for modulus of rupture (MOR) using metal cords. Samples having a low MOE, as well as samples having a higher MOE, were compared to non-reinforced LVL, referred to as a control group. As shown in the graph, reinforced LVL demonstrated a higher MOR than non-reinforced lumber. Moreover, low MOE samples reinforced with 4 layers 3×2-4 and 2 layers 3×2-16 demonstrated a greater MOR than non-reinforced lumber having a high MOE. LVL having a high MOE which was reinforced at a minimum level of 2 layers 3×2-4 showed an increase in MOR of approximately 18% in comparison to non-reinforced LVL.

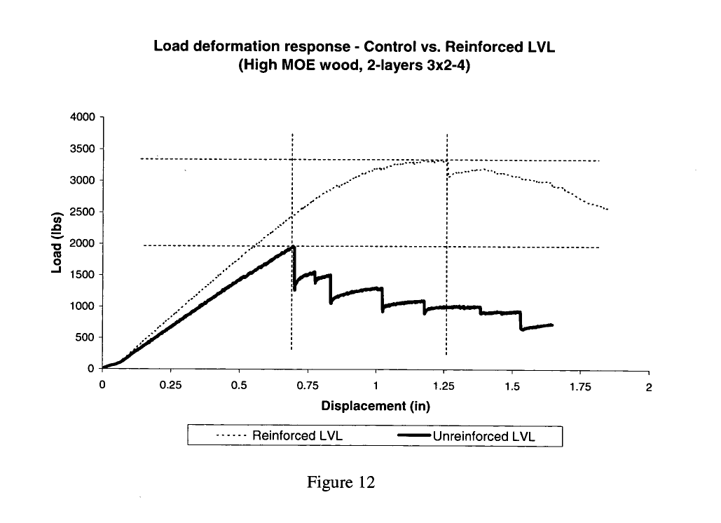

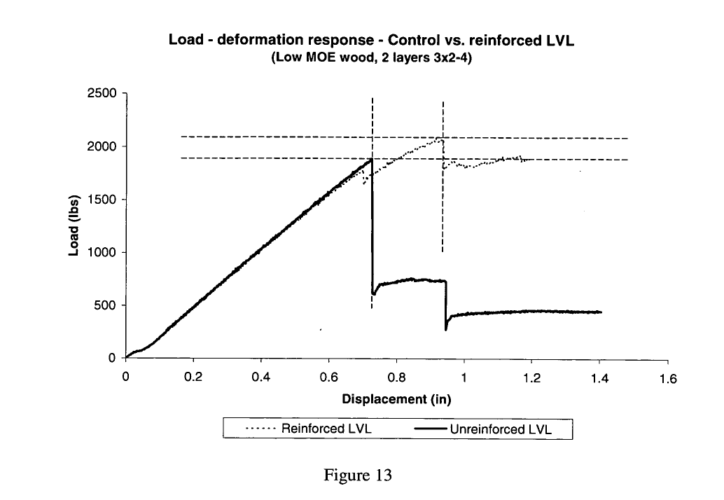

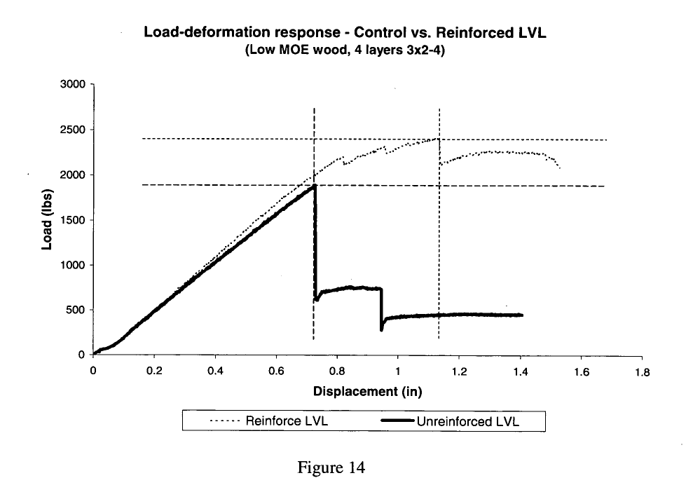

FIG. 12 illustrates results obtained in a comparison test for deformation response between LVL reinforced with metal cord (at 2 layers 3×2-4) and non-reinforced LVL, each having a high MOE. The results indicate that reinforced LVL supports a heavier load prior to failure and has greater stiffness, as indicated by the slope of the load-displacement curve. Moreover, reinforced LVL has greater ductility as indicated by the displacement maximum on the graph; and greater energy absorption characteristics, as indicated by the area under the load-displacement curve. FIG. 13 illustrates results obtained in a comparison test for deformation response between reinforced LVL (at 2 layers 3×2-4) and non-reinforced LVL, each having a low MOE. As expected, the reinforced LVL supports a heavier load prior to failure. Most notably, the non-reinforced LVL demonstrated a marked and rapid failure while the reinforced LVL had a more gradual decline after failure. FIG. 14 illustrates similar results for testing conducted using LVL having a low modulus of elasticity wherein the reinforced samples have 4 layers of cords comprising 3 strands which are wrapped by 2 strands, the cord density being 4 cords per inch.

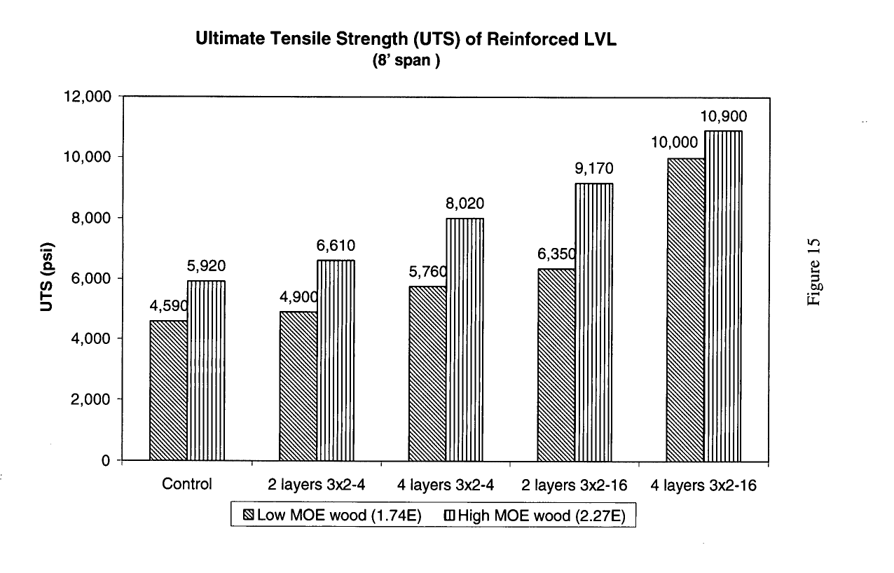

FIG. 15 illustrates results obtained during testing for tensile strength of LVL reinforced with metal cords. Similar to results obtained when testing for MOE and MOR, reinforced laminated veneer lumber demonstrated higher tensile strength than non-reinforced LVL. LVL which was reinforced with a 4 layers 3×2-16 treatment increased tensile strength of low MOE wood by approximately 118% and increased tensile strength of high MOE wood by approximately 84%.

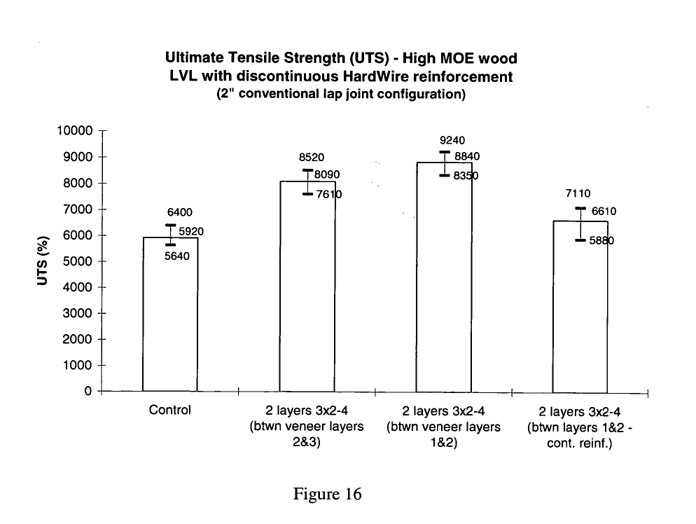

FIG. 16 illustrates results obtained during testing of wood layers reinforced with metal cords in a lap joint configuration similar to that shown in FIG. 2. Specifically, cords were applied to individual sections of a wood layer. As referred to in the graph, “veneer 1” is analogous to the wood layer 70; “veneer 2” is analogous to the wood layer 72; and “veneer 3” is analogous to the wood layer 74. Reinforcement between veneer 2 and veneer 3 produced a tensile strength 35% greater than non-reinforced layers in the same configuration. Reinforcement between veneer 1 and veneer 2 produced a tensile strength 48% greater than non-reinforced layers in the same configuration. Continuous reinforcement, i.e., placement of cords in a continuous length between the layer 70 and the layer 72, provided higher tensile strength than the control group as well. Moreover, the evidence indicates that a 2 inch overlap in a LVL lap joint is adequate to transfer tension stress from one cord section to the another cord section. This is due to the small diameter of the cords which make the reinforcement effectively continuous.

The above results demonstrate that wood products having wood layers reinforced by cords, whether directly applied or applied via a plastic scrim, demonstrate greater tensile strength, modulus of elasticity and modulus of rupture than non-reinforced wood products. Moreover, cords applied in separate sections to wood layers provided reinforcement properties comparable to those of wood layers reinforced with a continuous length of cords. Accordingly, the reinforced wood products may sustain heavier loads than non-reinforced wood products. The reinforced wood layers also have more energy absorption capacity after initial failure. This may provide users with sufficient notice after initial failure to evacuate a load-bearing area prior to occurrence of an accident.

Because of its demonstrated properties, the present invention may be implemented in a number of applications. For example, wood layers of a glulam beam and, in particular, an outer ply which bears a significant amount of tension, may be substituted with reinforced LVL layers to provide more resilient headers, beams and girders. In another embodiment, truss tension cords may be reinforced to increase a load capacity of trusses in cases where tensile failure is a predominant failure mode. In yet another embodiment, flanges of an I-joist may be reinforced to allow for greater spans. Moreover, wood products, such as walls constructed from reinforced wood layers, may be more resistant to, for example, weather effects, such as high winds from a hurricane or tornado.

While the embodiments of the invention have been illustrated and described, as noted above, many changes can be made without departing from the spirit and scope of the invention. Accordingly, the scope of the invention is not limited by the disclosure of the embodiments. Instead, the invention should be determined entirely by reference to the claims that follow.

What is claimed is:

1. A reinforced wood product comprising:
a first wood layer;
a second wood layer;
an adhesive between the first wood layer and the second wood layer; and
one or more cords positioned longitudinally between the first wood layer and the second wood layer in contact with the first wood layer and the second wood layer wherein the first wood layer, the second wood layer and the one or more cords, in combination, provide greater energy absorption than an amount of energy absorption provided by a combination of the first wood layer and the second wood layer and further wherein the one or more cords are constructed from a material selected from a group consisting of metal, plastic, rubber, fiberglass, carbon and graphite.

2. The reinforced wood product of claim 1 wherein each of the one or more cords have a diameter in a range from 0.030 inch to 0.060 inch.

3. The reinforced wood product of claim 1 wherein the adhesive is an epoxy.

4. The reinforced wood product of claim 1 wherein the cords have a density of at least 2 cords per inch along a width of the first wood layer.

5. The reinforced wood product of claim 1 wherein the material is metal.

6. The reinforced wood product of claim 1 wherein at least one of the one or more cords are shorter in length than the first wood section.

7. The reinforced wood product of claim 1 wherein the one or more cords are parallel to a grain of the first wood layer.

8. The reinforced wood product of claim 1 wherein the one or more cords are parallel to a grain of the first wood layer but are not parallel to a grain of the second wood layer.

9. The reinforced wood product of claim 1 wherein the cords are attached to a carrier.

10. A reinforced wood product comprising:
a plurality of wood layers in a stacked configuration;
a first wood layer within the plurality of wood layers;
a second wood layer within the plurality of wood layers wherein a top surface of the second wood layer contacts a bottom surface of the first wood layer;
an adhesive between the first wood layer and the second wood layer; and
a plurality of cords constructed from a metal positioned between the first wood layer and the second wood layer wherein the plurality of cords are parallel to a grain of the first wood layer and have a density of at least two cords per inch along a width of the first layer and further wherein the plurality of wood layers and the plurality of cords, in combination, provide greater energy absorption than an amount of energy absorption provided solely by the plurality of wood layers.

11. The reinforced wood product of claim 10 wherein the plurality of cords are non-parallel to a grain of the second wood layer.

12. The reinforced wood product of claim 10 further comprising:
a third wood layer within the plurality of wood layers wherein the third wood layer does not contact the first wood layer and the second wood layer; and
a plurality of metal cords attached to the third wood layer.

13. The reinforced wood product of claim 10 wherein the adhesive is an epoxy.

14. The reinforced wood product of claim 10 wherein the metal is steel.

15. The reinforced wood product of claim 10 wherein each of the plurality of cords have a diameter in a range from 0.030 inch to 0.060 inch.

16. A method for reinforcing a wood product, the method comprising the steps of:
applying an adhesive to a surface of a first wood layer;
positioning one or more cords adjacent to the surface of the first wood layer in a longitudinal direction along the surface wherein the cords are constructed from a material selected from a group consisting of metal, plastic, rubber, fiberglass, carbon and graphite;
placing a second wood layer adjacent to the surface of the first wood layer wherein the one or more cords are between the first wood layer and the second wood layer and wherein the first wood layer and the second wood layer are in contact; and
compressing the first wood layer, the second wood layer and the one or more cords.

17. The method of claim 16 wherein the first wood layer and the second wood layer have grains which are non-parallel to each other.

18. The method of claim 16 wherein the cords are attached to a carrier.
